(19) United States
(12) Patent Application Publication
(10) Pub. No.: US 2025/0378769 A1
(43) Pub. Date: Dec. 11, 2025

(54) TRAINING AID FOR CASUALTY CARE

(71) Applicant: RD Medical Training, McDonough, GA (US)

(72) Inventors: Joseph Ashley, McDonough, GA (US); Cole Malenich, McDonough, GA (US)

(21) Appl. No.: 19/202,286

(22) Filed: May 8, 2025

Related U.S. Application Data
(60) Provisional application No. 63/648,830, filed on May 17, 2024.

(51) Int. Cl. G09B 23/30; G09B 9/00; G09B 23/34

(52) U.S. Cl. CPC G09B 23/303; G09B 23/34; G09B 9/003

(57) ABSTRACT

The present disclosure relates to devices and methods for simulating active bleeding of wounds. The system can be used as a training aid for wound packing and tourniquet application. The system can be used in Tactical Combat Casualty Care (TCCC) to enhance medical training for military personnel. The device comprises a simulated appendage featuring distinct sections for wound packing and tourniquet application. Simulant blood is delivered through fluid channels, delivering blood to interchangeable wound profiles situated within the wound packing sections. This allows for varied training scenarios by repositioning the wound profiles across multiple sections of the appendage. Additionally, the tourniquet section includes channels enabling the cessation of blood flow upon correct application, providing clear visual feedback for successful training. The device effectively addresses key training goals: active bleeding simulation, visual feedback mechanisms, and variability in training scenarios, making it an invaluable tool for TCCC instruction.

### RELATED APPLICATIONS

The present application relates and claims priority to U.S. Provisional Application No. 63/648,830, filed May 17, 2024, which is hereby incorporated by reference in its entirety.

### FIELD

The present disclosure relates to devices and methods for simulating active bleeding and wounds on a limb or appendage, representing injuries that individuals may sustain during traumatic events. The present disclosure is particularly, but not exclusively, useful as a training aid for wound packing and tourniquet application, providing a hemorrhaging limb that is responsive to the application of pressure and wound packing.

### BACKGROUND

Tactical Combat Casualty Care (TCCC) is a combat training medicine course completed by all soldiers that teaches soldiers valuable skills such as tourniquet application, wound packing, and CPR. Soldiers in the military have access to a plethora of training aids to hone their skills for each section of TCCC training, but many soldiers do not achieve the readiness goals set by the military.

Current training aids for the rapid hemorrhaging section of TCCC training and similar training regimens do not adequately equip soldiers to save lives in combat situations. Trainees currently receive training on tourniquet application through practice on fellow soldiers. However, this not only causes discomfort and pain to the test subject, but also lacks visual feedback for the trainee to assess the effectiveness of their tourniquet application in reducing bleeding. Trainees also practice tourniquet application using pool noodles or IV arms; however, pool noodles lack a representation of blood flow, and IV arms fail to simulate active bleeding through wound profiles.

Other available training aids such as full-body or limb-specific (e.g., an arm) manikins are often very expensive and despite their high cost they fail to address the objective of effective tourniquet training which is to provide visual feedback of bleeding reducing with adequate pressure. While some training aids employ pressure sensors to trigger a green light to indicate when a tourniquet has reached the necessary pressure to halt bleeding in most cases, army medical instructors emphasize that this type of training is considerably less effective than directly observing bleeding stopping. Furthermore, while some training manikins provide pseudo-variable training because of many wound sections, they cannot be easily modified or changed.

There is a need for a rapid hemorrhaging training aids for military and first responders that simulate active bleeding through wound profiles, provide visual feedback to trainees to assess effectiveness of their tourniquet application in restricting or reducing bleeding, and provide variable and changeable training scenarios.

### SUMMARY

A device for simulating active bleeding and wounds on a limb or appendage may be used as a training aid for wound packing and tourniquet application. The device comprises an appendage resembling a human limb, a plurality of wound packing sections for receiving wound packing profiles, a section for tourniquet application, and a plurality of fluid channels for receiving simulant blood. Simulant blood can be delivered through the fluid channels, delivering blood to the wound packing sections and out of removable wound profiles disposed on one or more sections of the limb. The wound profiles are interchangeable and simulate different wound types such as gashes or bullet wounds. Instructors may vary the placement of wound profiles to present different scenarios to trainees. The tourniquet section can also include channels running through it so that when a user applies a torniquet to the tourniquet section, the tightening of the tourniquet and pressure applied by the tourniquet to the appendage can reduce or stop the flow of simulant blood. This causes the flow of simulant blood through the wound packing sections to stop, providing clear visual feedback of what a successful tourniquet looks and feels like.

In one example, a training aid is disclosed. The training aid includes a plurality of modular appendage units removably attachable to one another thereby forming a continuous appendage collectively resembling a human appendage upon assembly. The plurality of modular appendage units including at least one slot. Each modular appendage unit includes a fluid channel configured to enable passage of a fluid therethrough. The fluid channels of each modular appendage is configured to form a continuous fluid channel through the plurality of modular appendage units upon assembly. The fluid channels are operable to deliver a fluid to the at least one slot. The plurality of modular appendage units including at least one tourniquet section operable, upon compression force, to constrict a fluid channel disposed therein and at least partially preventing fluid flow through the at least one slot.

In another example, the training aid includes a plurality of attachment units configured to facilitate removable attachment of the plurality of modular appendage units.

In another example, the plurality of attachment units includes at least one protrusion and/or at least one recession disposed on each of the plurality of modular appendage units. The at least one protrusion is configured to couple to a recession of a corresponding attachment unit. The at least one recession is configured to couple to a protrusion of a corresponding attachment unit.

In another example, the at least one protrusion includes a threaded portion and the at least one recession includes a corresponding threaded recess.

In another example, the training aid includes at least one fastener configured to secure attachment of the plurality of modular appendage units.

In another example, the at least one fastener includes at least one pin configured to couple to at least one pin hole disposed on an outer surface of each of the modular appendage units and extending through each of the at least one attachment components. The at least one pin hole is configured to receive the at least one pin thereby securing attachment of the continuous appendage.

In another example, the plurality of modular appendage units includes a shoulder unit, an upper arm unit, a bicep unit, a forearm unit, and a hand unit.

In another example, the at least one slot is configured to receive an interchangeable wound profile. The interchangeable wound profile includes a first opening resembling a wound. The interchangeable wound profile includes a second opening configured to couple to the continuous fluid channel and receive a fluid.

In another example, the plurality of modular appendage units includes at least two slots, each fluidly coupled to the continuous fluid channel.

In another example, the plurality of modular appendage units includes at least two tourniquet section operable, upon compression force of both tourniquet sections, to constrict a fluid channel disposed therein and at least partially preventing fluid flow through the at least one slot.

In another example, the plurality of attachment components includes at least one protrusion and corresponding recession and at least one screw through hole and at least one corresponding screw receiving hole configured to receive a screw.

In one example, a modular appendage unit is disclosed. The modular appendage unit includes a flexible band defining a hollow passage. The modular appendage unit further includes an attachment unit configured to occupy the hollow passage. the attachment unit includes a protrusion and a recession. The protrusion is positioned on a first end of the attachment unit and the recession is positioned on a second end of the attachment unit. The protrusion is configured to couple to a recession of a corresponding attachment unit. The flexible band includes at least one fluid channel configured to enable passage of a fluid through the flexible band. The flexible band is configured, upon application of pressure, to compress thereby reducing or entirely restricting flow of fluid through the at least one fluid channel.

In another example, the modular appendage unit is operable, by the attachment unit, to removably attach to another appendage unit including the corresponding attachment unit thereby facilitating removeable connection of a plurality of appendage units.

In another example, the modular appendage unit comprises an upper arm section. The plurality of appendage units comprises a shoulder section, a bicep section, a forearm section, and a hand section.

In another example, the at least one fluid channel extends through the modular appendage unit and the plurality of appendage units thereby forming a continuous fluid channel.

In another example, at least one of the plurality of appendage units includes a slot fluidly coupled to the continuous fluid channel and configured to receive a wound profile.

In another example, the flexible band is configured to compress upon receiving pressure application by a tourniquet thereby reducing or entirely restricting flow of fluid through the at least one fluid channel.

In another example, a method for simulating active bleeding of wounds on a training aid is disclosed. The method includes assembling a training appendage resembling a human appendage by coupling a plurality of modular appendage units. The plurality of modular appendage units comprises a fluid channel and at least one slot. The fluid channel is configured to form a continuous fluid channel through the plurality of modular appendage units upon assembly. The at least one slot is configured to receive a wound profile. The at least one slot and the wound profile are fluidly coupled to the continuous fluid channel. The method further includes inserting the wound profile into the at least one slot. The method further includes connecting a pump to a fluid channel opening of a modular appendage unit of the plurality of modular appendage units. The method further includes pumping a fluid into the continuous fluid channel and out of the wound profile thereby simulating active bleeding of wounds.

In another example, the method further includes applying a flow restricting device to at least one of the plurality of module appendage units thereby at least partially restricting a flow of fluid exiting the wound profile.

In another example, the method further includes packing the wound profile with a wound packing material thereby at least partially restricting a flow of fluid existing the wound profile.

### BRIEF DESCRIPTION OF THE DRAWINGS

The skilled artisan will understand that the figures, described herein, are for illustration purposes only. It is to be understood that in some instances various aspects of the described implementations may be shown exaggerated or enlarged to facilitate an understanding of the described implementation. In the drawings, like reference characters generally refer to like features, functionally and/or structurally similar elements throughout the various drawings. The drawings are not necessarily to scale, emphasis instead being placed upon illustrating the principles of the teachings. The drawings are not intended to limit the scope of the present teachings in any way. The system and method may be better understood from the following illustrative description with reference to the following drawing in which:

FIG. 1 is an exploded assembly view of an implementation of an appendage for simulating active bleeding and wounds.

FIG. 2A shows an isometric view of a shoulder modular unit of an implementation of an appendage for simulating active bleeding and wounds.

FIG. 2B shows a side view of the shoulder modular unit of FIG. 2A.

FIG. 2C shows another isometric view of the shoulder modular unit of FIG. 2A.

FIG. 3A shows a view of a band of an upper arm modular unit of an implementation of an appendage for simulating active bleeding and wounds.

FIG. 3B shows a view of a bone body of an upper arm modular unit of an implementation of an appendage for simulating active bleeding and wounds.

FIG. 3C shows a view of the band of FIG. 3A connected to the bone body of FIG. 3B.

FIG. 4A shows a view of a bicep modular unit of an implementation of an appendage for simulating active bleeding and wounds.

FIG. 4B shows another view of the bicep modular unit of FIG. 4A.

FIG. 4C shows yet another view of the bicep modular unit of FIG. 4A.

FIG. 5A shows a view of a forearm modular unit of an implementation of an appendage for simulating active bleeding and wounds.

FIG. 5B shows another view of the forearm modular unit of FIG. 5A.

FIG. 5C shows yet another view of the forearm modular unit of FIG. 5A.

FIG. 6A shows a view of a hand modular unit of an implementation of an appendage for simulating active bleeding and wounds.

FIG. 6B shows another view of the hand modular unit of FIG. 6A.

FIG. 6C shows yet another view of the hand modular unit of FIG. 6A.

FIG. 7 shows a view of pins for securing an assembly of modular units of an implementation of an appendage for simulating active bleeding and wounds.

FIG. 8A shows an isometric view of a hose barb connector of an implementation of an appendage for simulating active bleeding and wounds.

FIG. 8B shows a side view of the hose barb connector of FIG. 8A.

FIG. 8C shows another isometric view of the hose barb connector of FIG. 8A.

FIG. 9A shows a view of an example wound profile of an implementation of an appendage for simulating active bleeding and wounds.

FIG. 9B shows a view of another example wound profile of an implementation of an appendage for simulating active bleeding and wounds.

FIG. 9C shows a view of yet another example wound profile of an implementation of an appendage for simulating active bleeding and wounds.

FIG. 9D shows a transparent view of the example wound profile of FIG. 9A.

FIG. 9E shows a transparent view of the example wound profile of FIG. 9B.

FIG. 9F shows a transparent view of the example wound profile of FIG. 9C.

FIG. 10 is an exploded assembly view of an implementation of an appendage for simulating active bleeding and wounds.

FIG. 11A shows a view of a bicep modular unit of an implementation of an appendage for simulating active bleeding and wounds.

FIG. 11B shows another view of the bicep modular unit of FIG. 11A.

FIG. 12A shows a view of a forearm modular unit of an implementation of an appendage for simulating active bleeding and wounds.

FIG. 12B shows another view of the forearm modular unit of FIG. 12A.

FIG. 13A shows a view of a hand modular unit of an implementation of an appendage for simulating active bleeding and wounds.

FIG. 13B shows another view of the hand modular unit of FIG. 13A.

FIG. 14 shows a flowchart of a method of training with an implementation of an appendage for simulating active bleeding and wounds.

FIG. 15 shows a flowchart of an example manufacturing method of an appendage training aid.

### DETAILED DESCRIPTION

The various concepts introduced above and discussed in greater detail below’ may be implemented in any of numerous ways, as the described concepts are not limited to any particular manner of implementation. Examples of specific implementations and applications are provided primarily for illustrative purposes.

References herein to positions of elements (e.g., “top”, “bottom”) are merely used to describe the orientation of various elements in the FIGURES. It should be noted that the orientation of various elements may differ according to other exemplary implementations, and that such variations are intended to be encompassed by the present disclosure.

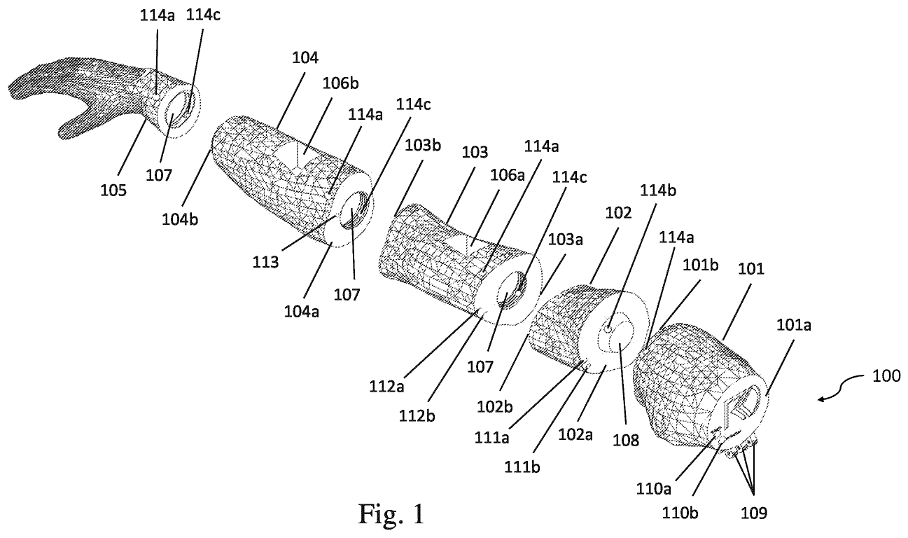

Referring now to FIG. 1, and in brief overview, an exploded assembly view of an implementation of a training appendage 100 (sometimes simply referred to as “appendage”) for simulating active bleeding and wounds is shown that includes an appendage 100 resembling a human limb. In some implementations the appendage 100 is a leg resembling a human leg. In some implementations, the appendage 100 is an arm resembling a human arm as shown in FIG. 1. In some implementations, the appendage 100 is a single unit (e.g., a full arm, a full leg). In some implementations, the appendage 100 is modular as shown in FIG. 1. The appendage 100 comprises a plurality of modular units that each represent a portion of a human arm including a shoulder modular unit 101, an upper arm modular unit 102, a bicep modular unit 103, a forearm modular unit 104, and a hand modular unit 105.

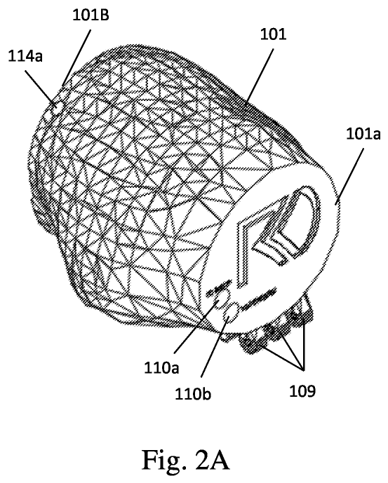

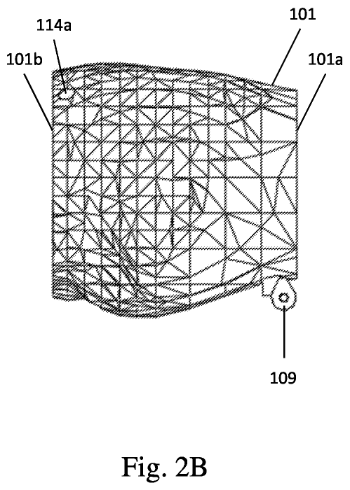

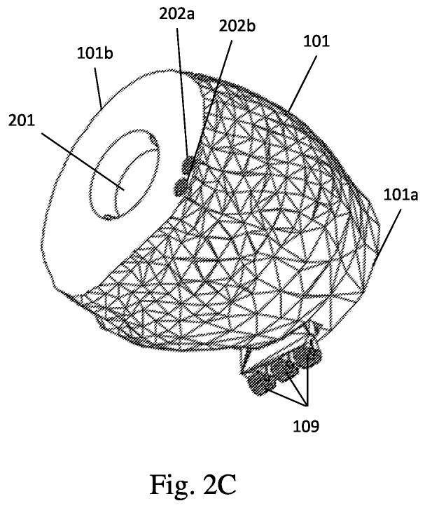

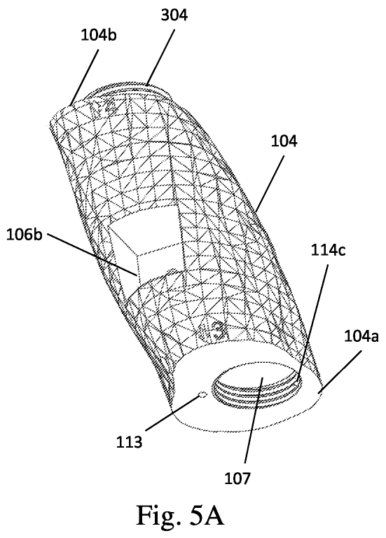

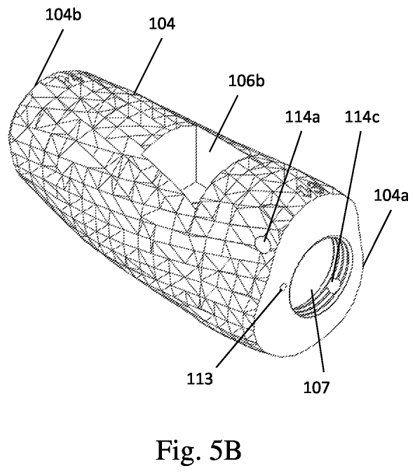

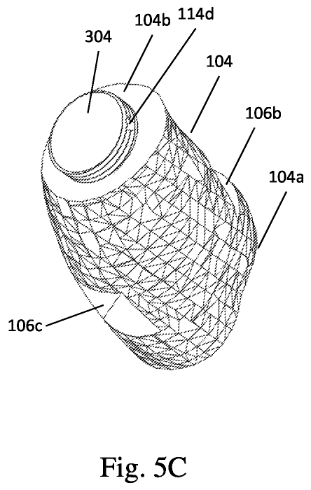

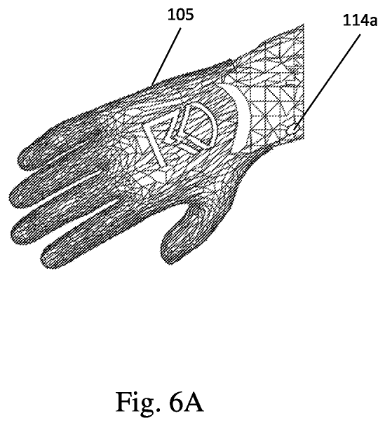

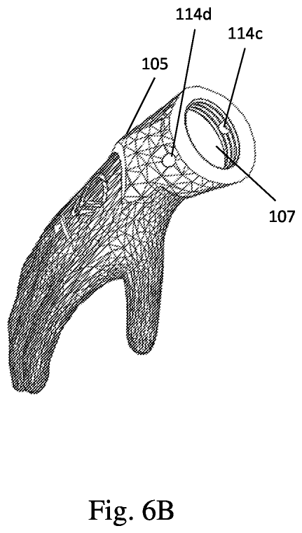

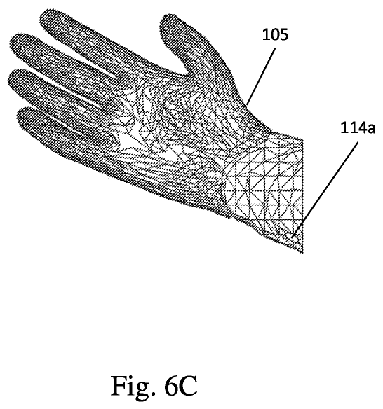

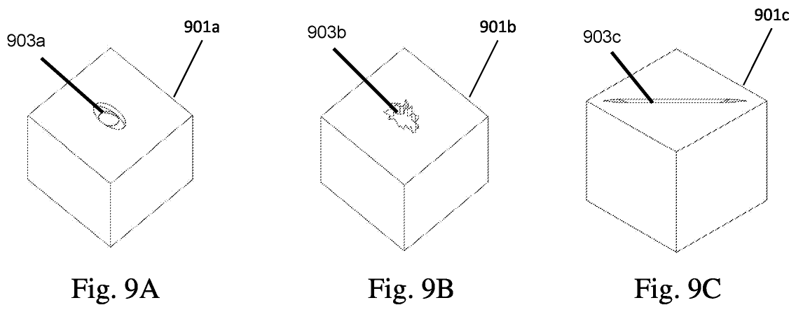

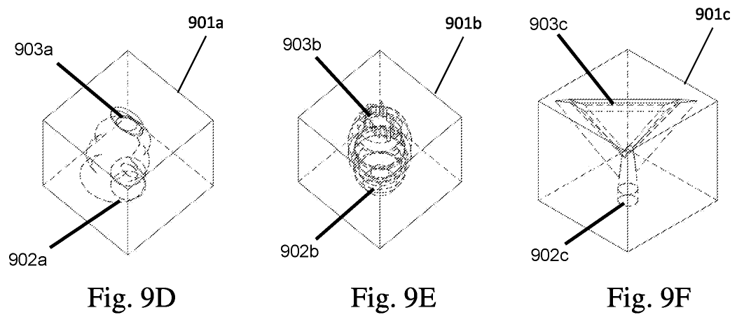

Still referring to FIG. 1, and in greater detail, and with additional reference to the views of the modular units shown in FIGS. 2A-6C, the appendage 100 further comprises one or more slots 106a, 106b, 106c incised on one or more modular units of the appendage 100. The slots 106a, 106b, 106c are recesses configured for receiving wound profiles (shown in FIGS. 9A-F). In some implementations, the slot 106a, 106b, 106c may be a rectangular recess, a circular recess, a polygonal recess, or an irregularly shaped recess.

The shoulder modular unit 101 includes a top end 101a and a second end 101b, in which the second end 101b comprises a recess 201. The upper arm modular unit 102 includes a top end 102a and a second end 102b, in which the first end 102a comprises a protruding surface 108 configured to couple with the recess 201 of the shoulder modular unit 101. The second end 102b of the upper arm modular unit 102 comprises a fastener surface 304 configured to couple with a recess 107 of a first end 103a of the bicep modular unit 103. A second end 103b of the bicep modular unit 103 comprises a fastener surface 304 configured to couple with a recess 107 of a first end 104a of the forearm modular unit 104. The second end 104b of the forearm modular unit 104 comprises a fastener surface 304 configured to couple with the recess 107 of the hand modular unit 105.

Each of the modular units is configured to couple with adjacent modular units. In this way, the modular units can be separated and assembled again using a connection mechanism between adjacent modular units. The connection mechanism holds the modular units together. The appendage 100 can be assembled and disassembled by a user which can be especially useful for storage and transportation of the appendage 100. The threads of the recess 107 are configured to match those of the fastener surface 304 allowing them to engage and form a secure connection when coupled together. The recess 107 and the fastener surface 304 are positioned on the ends of the modular units such that the coupling between adjacent modular units forms a contiguous exterior surface. In some implementations, the recess 107 and the fastener surface 304 are threaded to form a threaded connection. In some implementations, the connection mechanism between adjacent modular units are threaded inserts that can couple with threaded recesses 107. In those implementations, each of the fastener surfaces 304 are instead a threaded recess 107 that can also couple with the threaded insert. In other implementations, the connection mechanism between adjacent modular units are clips and latches. In other implementations, the connection mechanism between adjacent modular units are quick-release fasteners. In still other implementations, the connection mechanism between adjacent modular units are screw and screw hole connections. In still other implementations, the connection mechanism between adjacent modular units are snap fits. In still further implementations, the connection mechanism between adjacent modular units are magnetic connections in which each modular unit has a magnet positioned at one end, while the adjacent modular unit has a corresponding magnet placed at one end proximal to the magnet of the neighboring modular unit. The magnets on the modular units are aligned so that opposite poles face each other, thereby attracting and holding the modular units together via magnetic connection.

In several embodiments, each modular unit may be attached by a notched twist lock or key and keyway mechanism. For example, fastener surfaces 304 may include a protrusion or key on its side rather than threads. In this example, recess 107 may include a corresponding notch or keyway to frictionally couple to the protrusion or key of fastener surface 304. In this way, the notches or keyways of recess 107 are configured to match the protrusion or key of the fastener surface 304 allowing them to engage and form a secure connection when coupled together. The recess 107 and the fastener surface 304 are positioned on the ends of the modular units (e.g., 101a, 101b, 102a, 102b, 103a, 103b, 104a, and 104b) such that the coupling between adjacent modular units forms a contiguous exterior surface. Thus, the protrusion or key of fastener surfaces 304 and the notch or keyway of recess 107 are operable to cooperatively fasten to one another via a twisting motion, that is, by having the protrusion or key slide or fit into the notch or keyway. In some embodiments, each fastener surface 304 and recess 107 of each modular unit of appendage 100 include such a mechanism, such that collectively assembly creates a single continuous appendage.

However, in other some implementations, the connection mechanism may include a wide variety of attachment means including, but not limited to screws, bolts, nails, rivets, glue and other adhesives, welding, soldering, and other attachment means known in the art.

The shoulder modular unit 101 further comprises attachment points 109 disposed at edge of the first end 101a. The attachment points 109 can be used to secure the appendage 100 to a surface during use. For example, a torso of a manikin.

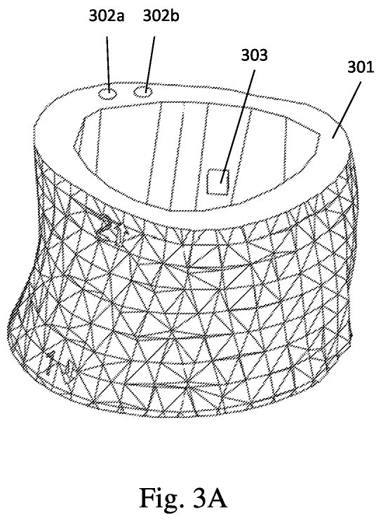

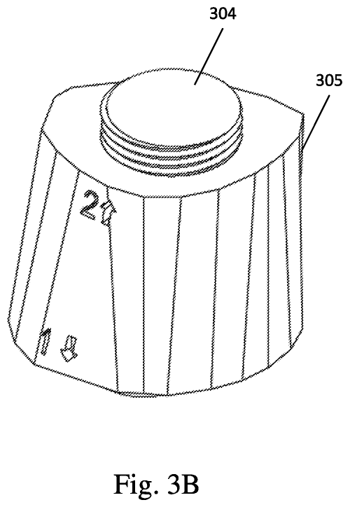

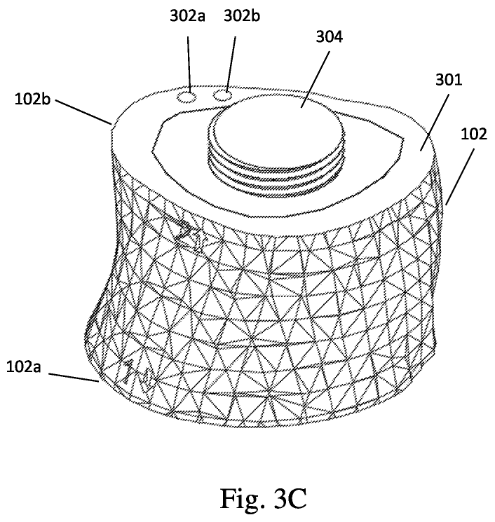

The first end 101a further comprises channel openings 110a, 110b. The fluid channel opening 110a is in fluid communication with one or more fluid channels disposed within the shoulder modular unit 101, the upper arm modular unit 102, the bicep modular unit 103, and one or more slots 106a, 106b, 106c. In some implementations, the fluid channel openings branch off or diverge into one or more channels disposed within the modular units. The one or more fluid channels extend from the opening 110a and direct the flow of fluid (e.g., simulant blood, water, dyed water) into distinct pathways within the modular units and out through the one or more slots 106a, 106b, 106c. Fluid flows from the channel opening 110a, through the one or more channels disposed within the shoulder modular unit 101, through a channel outlet 202a disposed on the second end 101b, and through the channel opening 111a disposed on the first end 102a of the upper arm modular unit 102. Fluid flows from the first end 102a of the upper arm modular unit 102, through the one or more channels disposed within the upper arm modular unit 102, through a channel outlet 302a (shown in FIG. 3C) disposed on the second end 102b, and through the channel opening 112a disposed on the first end 103a of the bicep modular unit 103. Fluid then flows through the one or more channels disposed within the bicep modular unit 103 and exits through the slot 106a. In several embodiments, each one or more slots 106a, 106b, 106c includes a corresponding fluid channel, which terminates at its corresponding slot.

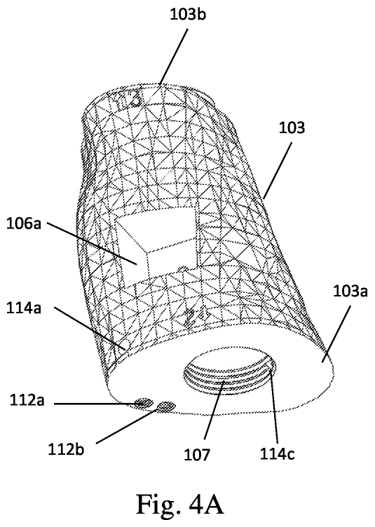

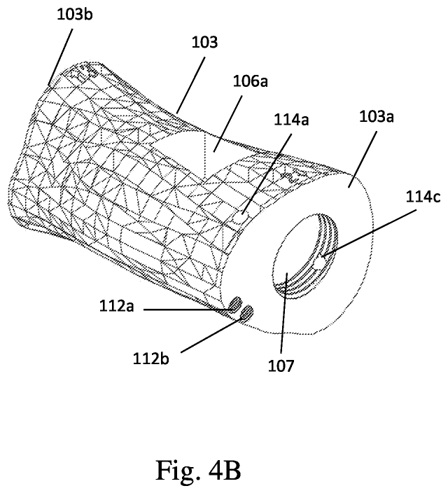

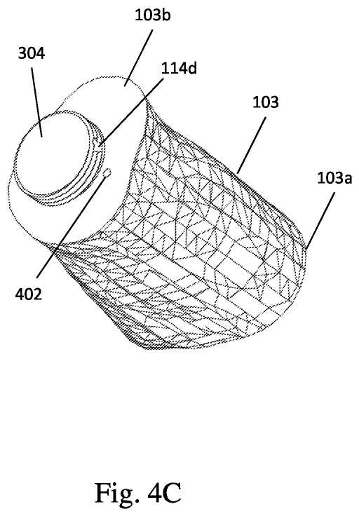

The channel opening 110b is in fluid communication with one or more channels disposed within the shoulder modular unit 101, the upper arm modular unit 102, the bicep modular unit 103, the forearm modular unit 104, and one or more slots 106a, 106b, 106c. Fluid flows from the channel opening 110b, through the one or more channels disposed within the shoulder modular unit 101, through the channel outlet 202b disposed on the second end 101b, and through the channel opening 111b disposed on the first end 102a of the upper arm modular unit 102. Fluid flows from the first end 102a of the upper arm modular unit 102, through one or more channels disposed within the upper arm modular unit 102, through channel outlet 302b (shown on FIG. 3C) disposed on the second end 102b, and through the channel opening 112b disposed on the first end 103a of the bicep modular unit 103. Fluid then flows through one or more channels disposed within the bicep modular unit 103, through channel outlet 402 (shown in FIG. 4C) disposed on the second end 103b, and through the channel opening 113 disposed on the first end 104a of the forearm modular unit 104. Fluid then flows through the one or more channels disposed within the forearm modular unit 104, and exits through the slots 106b, 106c. It should be understood that additional channel openings and channel outlets disposed on the ends of the modular units with channels extending from those additional channel openings can be used to flow fluid to slots not illustrated in FIG. 1. By way of example, channel openings on one end of the hand modular unit 105 can be used to flow fluid through the modular unit 105 and through one or more slots incised on the modular unit 105. In this example, the forearm modular unit 104 further comprises a channel outlet on the second end 104b and one or more channels in fluid communication with the channel opening 113 so that fluid can flow from the shoulder modular unit 101 to the hand modular unit 105. In some implementations, the cross sections of the channels are circular. In those implementations, the channels can be modeled after physiological arteries. In other implementations, the cross sections of the channels are rectangular, triangular, polygonal, or irregularly shaped.

In some implementations, a siphon hand pump can be connected to the channel openings 110a, 110b of the shoulder modular unit 101 to flow fluid through the appendage 100. In other implementations, a peristaltic pump can be connected to the channel openings 110a, 110b of the shoulder modular unit 101. In still other implementations, a syringe pump can be connected to the channel openings 110a, 110b of the shoulder modular unit 101. In still further implementations, a gear pump can be connected to the channel openings 110a, 110b of the shoulder modular unit 101. In some implementations, a pulse-free fluid flow can be supplied through the appendage 100. In other implementations, a pulsatile fluid flow can be supplied through the appendage 100.

Referring now to FIGS. 3A-C, and in brief overview, views of an implementation of an upper arm modular unit 102 is shown. In several embodiments, to facilitate TCCC training and more particularly to simulate slowing or stopping active bleeding, a flexible band including the fluid flow channels is included operable, via compressive force (e.g., via a tourniquet), to slow or stop the flow of fluid to the one or more slots 106a, 106b, 106c. FIG. 3A shows a band 301, channel openings 302a, 302b, and an internal slot 303 of the upper arm modular unit 102. FIG. 3B shows a bone body 305 or “attachment unit” and a fastener surface 304 disposed on one end of the bone body 305 of the upper arm modular unit 102. In some implementations, the bone body 305 is 3D printed. In some implementations, the bone body 305 is made of polyvinyl chloride, polyurethane, polycarbonate, acrylonitrile butadiene styrene, or other plastics. In some implementations, the band 301 is made of silicone, thermoplastic elastomers, latex, or gel-filled silicone. The band 301 may be referred to as a tourniquet section as it is configured to restrict flow of fluid through the one or more channels upon application of a tourniquet via compression of the band 301, thereby constricting flow of fluid therein. In many implementations, appendage 100 includes a single tourniquet section; however, in some implementations, appendage 100 includes multiple tourniquet sections (e.g., 2 or more).

The one or more channels disposed within the modular units are disposed within the band 301. The band 301 is made from a flexible and/or resilient material, allowing it to stretch and compress. When a tourniquet is applied around a modular unit (e.g., upper arm modular unit 102) of an assembled appendage, pressure exerted on the band 301 reduces or entirely restricts the flow of fluid to the one or more slots 106a, 106b, 106c located downstream from where the tourniquet is applied. The pressure threshold required to stop fluid flow in the arm using a tourniquet is comparable to the pressure threshold required to stop bleeding in the arm of a male adult using the same tourniquet. The user or trainee can apply the tourniquet to the assembled appendage to train for tourniquet application. The reduction and restriction of fluid flowing through the slots 106 and respective wound profiles 109a, 109b, 109c inserted in the slots 106a, 106b, 106c serve as a visual indicator and visual feedback to the trainee or user as they tighten the tourniquet and indicate to the user when the tourniquet application is effective. For clarity, band 301 includes channels 302a, 302b and is of a material to allow compression. Such compression, for example by a tourniquet, causes channels 302a, 302b to be constricted, which reduces or entirely restricts the flow of fluid to the one or more slots 106a, 106b, 106c. Advantageously, and as discussed in more detail later, the flexible material of band 301 may be configured to simulate the requisite pressure needed to stop bleeding of a human appendage by altering the composition of band 301 (e.g., silicon composition).

Still referring to FIGS. 3A-C, and in greater detail, FIG. 3C shows the band 301 wrapped around the bone body 305 or attachment unit such that the substantially planar ends of the band 301 and the bone body 305 are aligned. In some implementations, each of the modular units 101, 102, 103, 104, 105 comprises a band 301 that wraps around a bone body 305 in which the band 301 and the bone body 305 are sized and shaped according to the portion of the appendage that it resembles. However, in many embodiments, only upper arm unit 102 comprises a band 301 wrapped around a bone body 305. The inner surface of the band 301 is shaped so that it conforms to the outer surface of the bone body 305. The outer surface of the band 301 resembles the external surface of the portion of the appendage it resembles. In some implementations, the band 301 is dyed or colored to resemble different skin tones. In other implementations, the band 301 is dyed or colored orange, red, blue, green, or any other color. In some embodiments, only the tourniquet section includes a flexible band 301 encompassing a bone body 305. In these embodiments, the remaining modular units (e.g., modular unit 101, 103, 104, and 105) are on-piece units with attachment means integrally formed therein.

In some implementations, the bone body 305 comprises a projection disposed on the outer surface of the bone body 305 that engages with the internal slot 303 on the band 301 to form a connection between the band 301 and the bone body 305. The band 301 can be secured to the bone body 305 with a connection mechanism to prevent the band from slipping on the bone body 305 during any mechanical manipulation of any of the modular units.

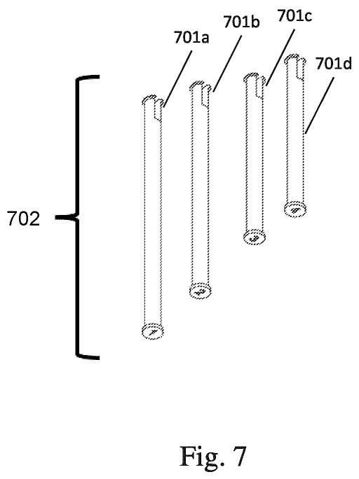

Referring now to FIG. 7, a view of pins 701a, 701b, 701c, 701d or a collection of pins 702 for securing an assembly of modular units of an implementation of an appendage for simulating active bleeding and wounds is shown. In some implementations, the collection of pins 702 (i.e., pins 701a, 701b, 701c, 701d) are cotter pins (i.e., split pins, cotter keys). In other implementations, the pins 701a, 701b, 701c, 701d are R-clips (i.e., R-pins, hairpin cotter pins). In still other implementations, the pins 701a, 701b, 701c, 701d are spring pins. In several embodiments, the pins 701a, 701b, 701c, 701d vary in longitudinal length, with each pin's length corresponding to the depth of the pin hole shaft the pin is inserted into.

Still referring to FIG. 7 and with additional reference to FIGS. 1-6C, the modular units 101, 102, 103, 104, 105 (i.e., the bicep, the forearm, and the hand modular unit) may each comprise a pin hole 114a, 114b, 114c, 114d, proximal to one end of the modular unit. For example, the pin holes 114a are positioned on the outer surface of the band 301 and extend along the concentric axis of the pin hole 114a from the outer surface of the band 301, through the bone body 305 to the circumference edge of the recess 107 that is proximal to the pin hole 114a, and through a portion of the bone body 305 on the opposite side, diametrically opposed (i.e., pin hole recess 114c). As another example, the fastener surface 304 of modular units 102, 103, 104, 105 further comprise a pin hole 114d that extends from one point on the circumference edge of the fastener surface 304 to another point on the circumference edge, diametrically opposed. When two adjacent modular units are coupled together via a connection mechanism, the connection can be further secured using a pins 701a, 701b, 701c, 701d. The connection mechanism is configured to align the pin holes 114a, 114c of one modular unit with the pin hole 114d of an adjacent modular unit. A pin 701a, 701b, 701c, 701d can be inserted through the pin holes 114a, 114b, 114c, 114d.

The shoulder modular unit 101 comprises a pin hole 114a proximal to the second end 101b that extends along the concentric axis of the pin hole 114a from the outer surface of the band 301, through the bone body 305 to the circumference edge of the recess 201 that is proximal to the pin hole 114a and through a portion of the bone body 305 on the opposite side, diametrically opposed. The protruding surface 108 further comprises a pin hole 114b that extends from one point on the circumference edge of the protruding surface 108 to another point on the circumference edge, diametrically opposed. When the shoulder modular unit 101 and the upper arm modular unit 102 are coupled together via a connection mechanism, the connection can be further secured using a pin 701a, 701b, 701c, 701d. The connection mechanism (e.g., threaded protrusion and recession) may be configured to align the pin holes upon connection. For example, the connection mechanism is configured to align the pin hole 114a of the shoulder modular unit 101 with the pin hole 114b of the upper arm cross modular unit 102. The pin 701a can be inserted through the pin holes 114a, 114b to secure the connection between the shoulder unit 101 and the upper arm modular unit 102.

Additionally or alternatively and with reference to FIGS. 1-6C, the modular units 101, 102, 103, 104, 105 (i.e., the bicep, the forearm, and the hand modular unit) may each include a bolt or screw fastening connection to secure their connection to one another. Advantageously, a bolt or screw fastening connection transfers the connective load to a compression force between the modular unit.

To facilitate the foregoing, each modular unit 101, 102, 103, 104, and/or 105 may include at least one groove to accompany the bolt or screw and a corresponding threaded hole to receive the bolt or screw. The at least one groove may be a depression formed on the body of modular units 101, 102, 103, 104, and/or 105 and extending vertically along the length of the modular unit 101, 102, 103, 104, and/or 105. The depression or groove may be configured to accommodate the bolt or screw such that it may fit within the depression or groove as it extends from one modular unit into the adjacent modular unit, screwing therein and consequently fastening the units together. The corresponding threaded hole may be configured to receive the bolt or screw and may be disposed on a perpendicular surface of the modular units 101, 102, 103, 104, and/or 105 adjacent to fastening surface 304. In several embodiments, each modular unit 101, 102, 103, 104, and/or 105 includes at least one screw or bolt and threaded hole pair; however, the present disclosure contemplates embodiments with two or more screw or bolt and threaded hole pair.

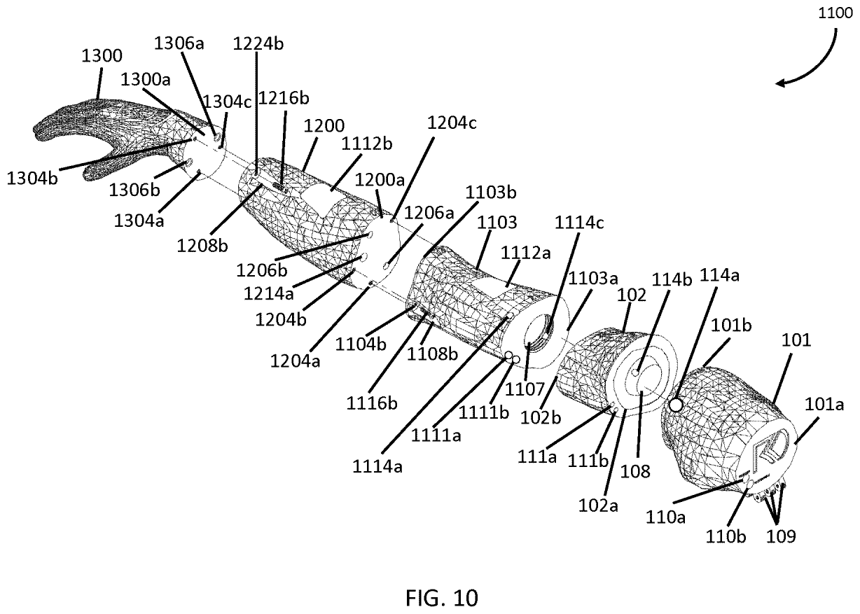

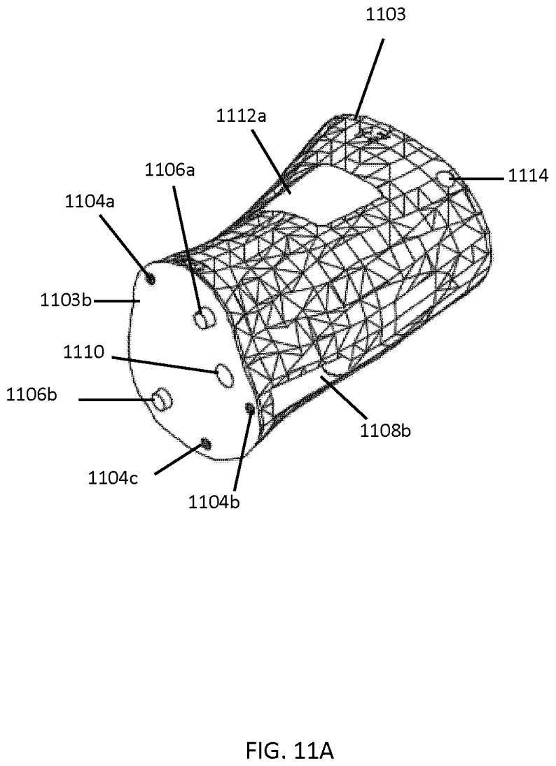

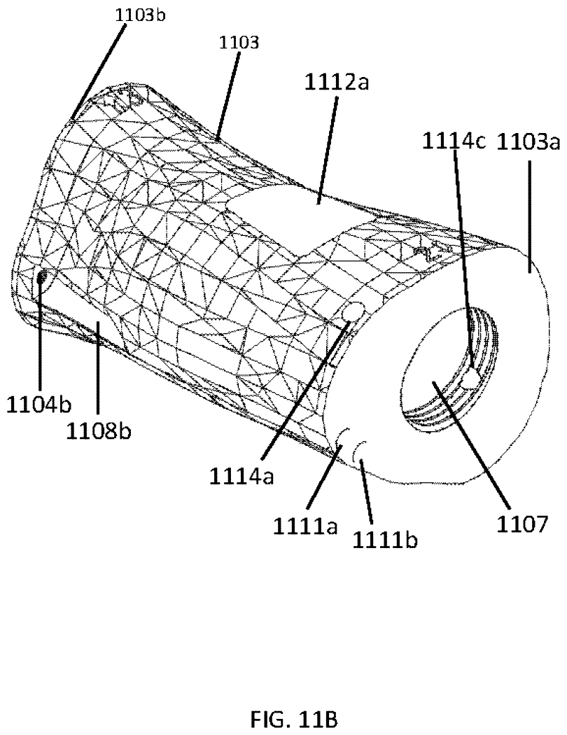

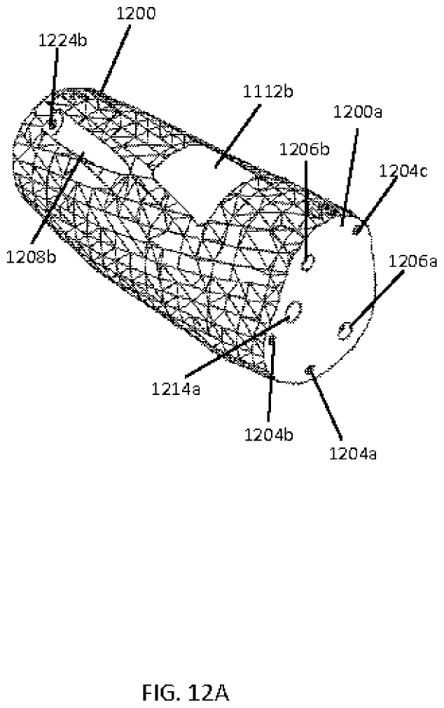

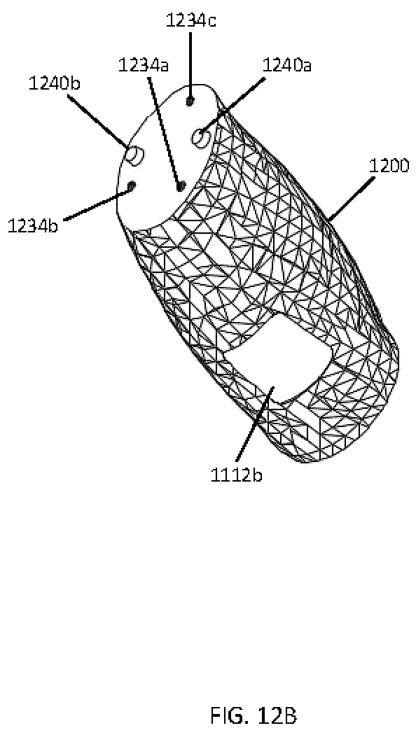

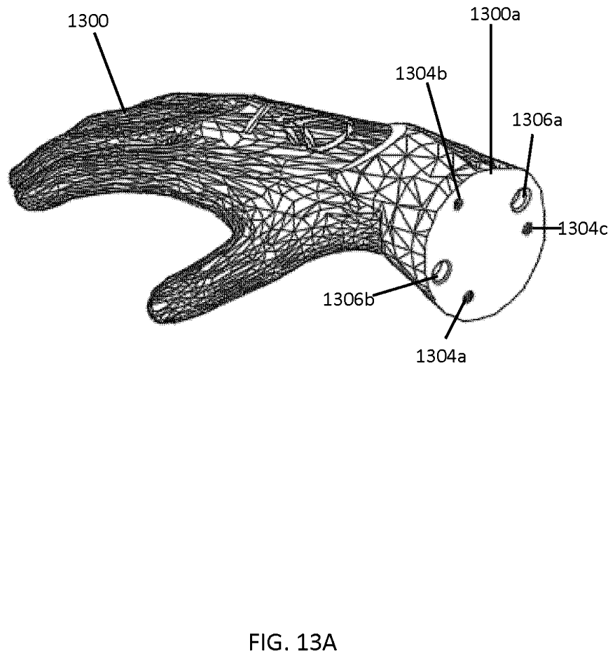

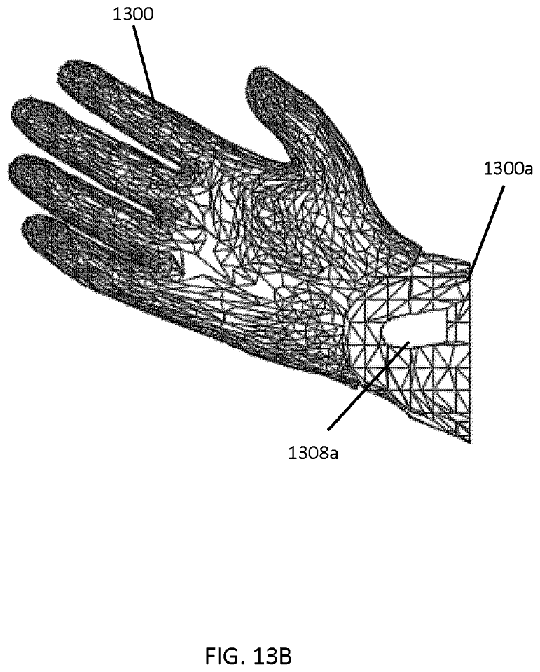

In some embodiments, the screw or bolt fastening connection may be cooperatively aligned with the notched twist lock or key and keyway mechanism such that as the modular units are twisted together, the key and keyway cause the groove and threaded hole to be aligned. Thus, enabling the operator to assemble the appendage 100 by twisting the modular units together and then screwing in the screw or bolt to secure the connection. Advantageously, these embodiments provide for a secure connection configured to withstand rough use of appendage 100 which may be present when undergoing TCCC training. Such embodiments are discussed in detail with reference to FIGS. 10-13B.

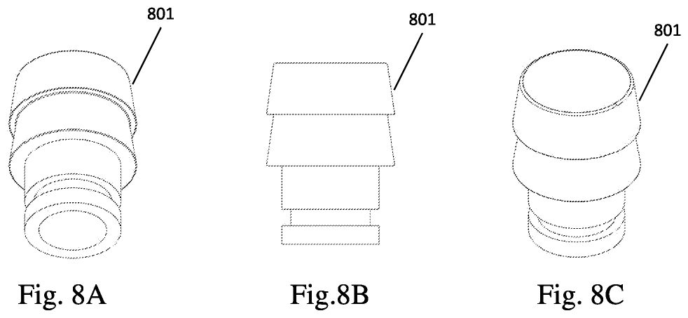

Referring now to FIGS. 8A-C, views of hose barb connector of an implementation of an appendage for simulating active bleeding and wounds is shown. In various implementations, hose barb connector 801 can be used to prevent fluid leakage in the band 301 of the upper arm modular unit 102. This can be especially useful when the upper arm modular unit 102 is compressed with a tourniquet. Hose barb connecters 801 can be inserted into channel openings 111a, 111b and channel outlets 302a, 302b to maintain the fluid connection with adjacent modular units (i.e., the shoulder modular unit 101 and the bicep modular unit 103). For clarity appendage 100 may employ multiple barb connectors 801 between various fluid channels therein to provide a liquid tight, airtight, and/or hermetic seal therebetween.

Referring now to FIGS. 9A-F, and in brief overview, views of wound profiles 901a, 901b, 901c of an implementation of an appendage for simulating active bleeding and wound are shown. Wound profiles 901a, 901b, 901c serve as an intermediary components to allow fluid flowing from the one or more fluid channels to exit the one or more slots thereby simulating active bleeding. Where compression force is applied to the tourniquet section, bleeding simulation through wound profiles 901a, 901b, 901c may be reduced or entirely halted, thereby simulating TCCC training. FIGS. 9A and 9D show a view and transparent view, respectively, of a small bullet hole wound profile 901a. FIGS. 9B and 9E show a view and transparent view, respectively, of a large bullet hole wound profile 901b. FIGS. 9C and 9F show a view and transparent view, respectively, of a slash wound profile 901c. In some implementations, the wound profiles 901a, 901b, 901c are made of silicone, thermoplastic elastomers, latex, or gel-filled silicone. In some implementations, the wound profiles 901a, 901b, 901c are made of the same material as the band 301 of the modular units. In some implementations, the wound profiles 901a, 901b, 901c are made of materials different from the band 301 of the modular units.

Still referring to FIGS. 9A-F, and in greater detail, wound profiles 901a, 901b, 901c can be inserted into slots 106a, 106b, 106c. Wound profiles 901a, 901b, 901c are sized and shaped to align with the dimensions of the slots 106a, 106b, 106c. In some implementations, the wound profiles 901a, 901b, 901c may be different 3-dimensional shapes such as a cube, rectangular prism, cylinder, a polygonal prism, or an irregular shape. Wound profiles 901a, 901b, 901c can be removed and replaced with each other in different slots 106a, 106b, 106c. It should be understood that other wound profiles from those illustrated are possible. By way of example, other wound profiles may include stab wounds, puncture wounds, lacerations, or avulsions.

Each wound profile 901a, 901b, 901c further comprises two openings. The first openings 902a, 902b, 902c are disposed on the bottom surface of the wound profiles 901a, 901b, 901c, respectively, and are positioned so that it is in fluid communication with the fluid exiting from the slot 106a, 106b, 106c that the wound profile 901a, 901b, 901c are inserted into. The second openings 903a, 903b, 903c are disposed on the top surface of the wound profile 901a, 901b, 901c, respectively, and models the geometry of the wound it resembles. When a wound profile 901a, 901b, 901c is inserted in a slot 106a, 106b, 106c, the top surface of the wound profile 901a, 901b, 901c can be substantially contiguous with the exterior surface of the appendage. When the wound profiles 901a, 901b, 901c are inserted into the slots 106a, 106b, 106c and fluid is flowed through the assembled appendage, fluid exits through the second openings 903a, 903b, 903c of the wound profiles 901a, 901b, 901c. Compression force via, for example, a tourniquet may be applied to the tourniquet section (e.g., upper arm modular unit 102) of appendage 100 thereby restricting flow of fluid through the one or more fluid channels to reduce or entirely restrict flow of fluid exiting the wound profile 901a, 901b, 901c. Thus, the user, operator, or trainee can practice tourniquet application while receiving visual feedback to better facilitate TCCC training. Wound packing materials can be sufficiently packed into one or more wound profiles 901a, 901b, 901c to reduce or entirely restrict the flow of fluid exiting the packed wound profile 901a, 901b, 901c. The user, operator, or trainee can apply wound packing materials to one or more wound profiles 901a, 901b, 901c to train for wound packing. Advantageously, the reduction and restriction of fluid flow exiting the packed wound profile serves as visual feedback to the trainee or user as they pack the wound with wound packing materials. In some implementations, the wound packing material is plain gauze, hemostatic gauze, or a hemostatic agent.

Referring now to FIG. 10, and in brief overview, an exploded assembly view of an implementation of a training appendage 1100 for simulating active bleeding and wounds is shown that includes an appendage 1100 resembling a human limb. In many respects, training appendage 1100 may be substantially analogous to that of training appendage 100 redundant explanation of which is excluded for clarity. For example, training appendage 1100 may include a plurality of modular units (e.g., shoulder modular unit 101, upper arm modular unit 102, bicep modular unit 1103, forearm modular unit 1200, and hand modular unit 1300) operable to attach to one another, collectively resembling a human appendage upon assembly and collectively operable to simulate bleeding through one or more wound profile accommodating slots (e.g., slots 1112a, 1112b) and fluid channels (e.g., via fluid channel openings 1114a, 1114b, 1206b). Additionally, training appendage 1100 may be operable to facilitate TCCC training by including upper arm modular unit 102 operable to restrict fluid flow upon application of a tourniquet, redundant explanation of which is excluded for clarity.

However, FIG. 10 illustrates a training appendage 1100 with at least one modular unit that utilizes a screw or bolt attachment mechanism (i.e., via screws or bolts 1116b, 1216b) rather than the threaded protrusion and recession attachment mechanism described with reference to FIGS. 1-6C. To facilitate the foregoing, and as illustrated in FIG. 10, one or more modular unit may include at least two protrusions configured to couple to at least two recessions in an adjacent modular unit while one or more other modular units may include the attachment means described with reference to training appendage 100. Such protrusions and recessions may be a snap fit. While two protrusions and recessions are illustrated in FIGS. 10-13B, training appendage 1100 may include less or more per modular unit. Additionally, each modular unit may include at least one screw or bolt hole configured to accommodate a screw or bolt to enable each modular unit to be fastened to one another. In these embodiments, screws may be screwed into a perpendicular surface of the modular unit (e.g., surface 1200a, 1300a) from a surface (e.g., surface 1103b, 1200b) of a corresponding modular unit via pass through screw holes (e.g., holes 1104a, 1104b, 1104c, 1224b, 1224c) into screw receiving holes (e.g., holes 1204a, 1204b, 1204c, 1304b, 1304c). Additionally, each modular unit may include a depression configured to accommodate the screw or bolt such that the bolts or screws may be turned and fastened with ease. Collectively, one or more modular units may be screwed to one another advantageously transfer attachment force to a compressive load. As previously discussed, such a mechanism may be advantageous to provide sturdier attachment which may be necessary during TCCC training.

Referring now to FIGS. 10-13B collectively, training appendage 1100 includes the shoulder modular unit 101 and upper arm modular unit 102 of training appendage 100. In several embodiments, training appendage 1100 further includes bicep modular unit 1103 including recession 1107 that utilizes threaded attachment means to fasten to upper arm modular unit 102 (i.e., via a corresponding threaded protrusion 304). Bicep modular unit 1103 may be substantially analogous to bicep modular unit 103 and include channel opening 1111a, 1111b and wound profile 1112a redundant explanation of which is excluded for clarity. However, bicep modular unit 1103 includes at least one screw accommodating depressions, such as screw accommodating depression 1108b, each of which may include a corresponding screw accommodating through holes 1104a, 1104b, 1104c. Each through hole 1104a, 1140b, 1104c of bicep modular unit 1103 is configured to allow a screw to pass therethrough and into corresponding screw receiving holes 1204a, 1204b, 1204c of forearm modular unit 1200. For illustrative purposes, only depression 1108b is shown however one of ordinary skill in the art will appreciate that each hole 1104a, 1104b, 1104c includes a corresponding depression to enable a screw to be placed and screwed therein. Additionally, bicep modular unit 1103 includes a first protrusion 1106a and a second protrusion 1106b configured to couple to corresponding recessions 1206a, 1206b of forearm modular unit 1200. As such, protrusions 1106a, 1106b may be aligned with recessions 1206a, 1206b and a screw or bolt (e.g., screw or bolt 1116b) may be screwed through holes 1104a, 1104b, 1104c to couple bicep modular unit 1103 to forearm modular unit 1200. In several embodiments, each protrusion and each recession are aligned to ensure each fluid channel opening aligns with that of a corresponding modular unit thereby enabling forming of continuous fluid channels for simulation of bleeding.

Forearm modular unit 1200 may be substantially analogous to forearm modular unit 104 and include channel opening 1214a and slot 1112b redundant explanation of which is excluded for clarity. Forearm modular unit 1200 may include a first protrusion 1240a and a second protrusion 1240b configured to couple to a first recession 1306a and a second recession 1306b of hand modular unit 1300. Additionally, forearm modular unit 1200 may include one or more screw through holes 1234b, 1234c, while hand modular unit 1300 includes one or more corresponding screw receiving holes 1304b, 1304c. In some embodiments, hand modular unit 1300 includes screw through hole 1304a and forearm modular unit 1200 includes screw receiving hole 1234a. In these embodiments, a screw accommodating depression 1308a is included on hand modular unit 1300. Such that forearm modular unit 1200 may be fastened to hand modular unit 1300 via screw or bolt connection. In several embodiments, forearm modular unit 1200 includes at least two screw accommodating depressions (e.g., depression 1208b) such that screws may be fastened with ease. In some embodiments, at least one screw accommodating depression is included on hand modular unit 1300 (e.g., depression 1308a). As such, protrusions 1240a, 1240b may be aligned with recessions 1306a, 1306b and a screw or bolt (e.g., screw or bolt 1116b) may be screwed through holes 1234a, 1234b, 1234c to couple forearm modular unit 1200 to hand modular unit 1300. In several embodiments, protrusions 1240a, 1240a and recessions 1306a, 1306b are aligned to ensure the assembled appendage 1100 resembles a human appendage (e.g., human arm).

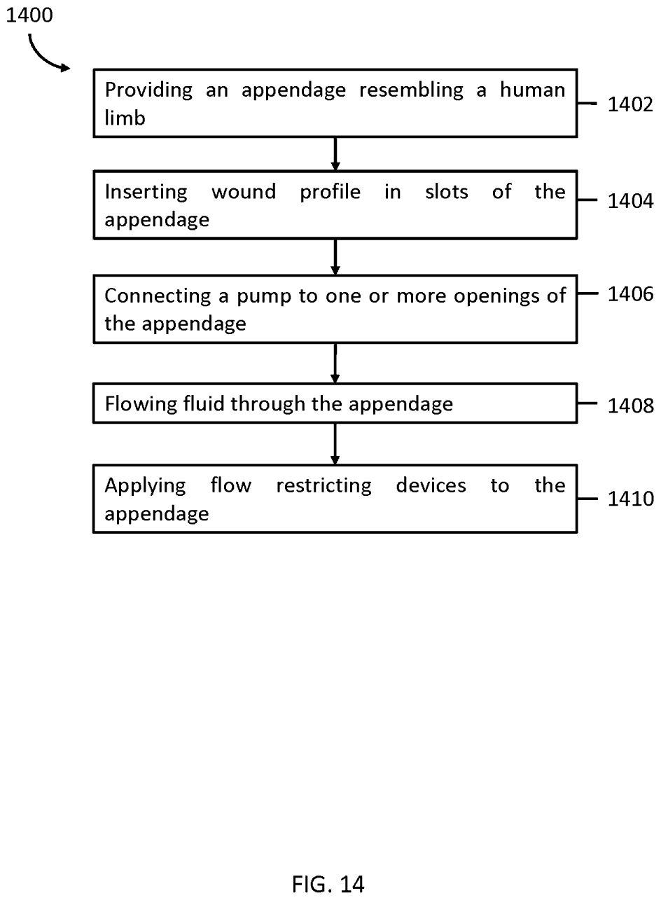

Referring now to FIG. 14, and in brief overview, a flowchart of a method 1400 of training with an implementation of an appendage for simulating active bleeding and wounds is shown. The method 1400 includes: a step 1402, providing an appendage resembling a human limb (e.g., training appendage 100 or 1100), a step 1404, inserting wound profiles (e.g., wound profiles 901a, 901b, 901c) in slots (e.g., slots 106a, 106b, 106c, 1112a, 1112b) of the appendage (e.g., appendage 100 or appendage 1100), a step 1406, connecting a pump to the one or more openings of the appendage, a step 1408, flowing fluid through the appendage, and a step 1410, applying flow restricting devices (e.g., tourniquet, wound packing materials).

At step 1402, providing an appendage resembling a human limb, further comprises assembling the appendage. For example, at step 1402, appendage 100 or appendage 1100 may be assembled. A user assembles the appendage (e.g., appendage 100, 1100) by coupling modular units 101,102,103,104,105 or modular units 101, 102, 1103, 1200, 1300 using the connection mechanism between the modular units (e.g., threaded protrusion and recession or screw and screw hole). For example, the user couples the second end 101b of the shoulder modular unit 101 with the first end 102a of the upper arm modular unit 102. The coupled modular units 101, 102 are then coupled with the bicep modular unit 103 by coupling the second end 102b of the upper arm modular unit 102 to the first end 103a of the bicep modular unit 103. The coupled modular units 101,102,103 are then coupled with the forearm modular unit 104 by coupling the second end 103b of the bicep modular unit 103 to the first end 104a of the forearm modular unit 104. The coupled modular units 101,102,103,104 are then coupled with the hand modular unit 105 by coupling the second end 104b of the forearm modular unit 104 to one end of the hand modular unit 105. A similar process may be applied to training appendage 1100. In some implementations, two or more users may assemble the appendage in parallel. It should be understood that while the modular units 101,102,103,104,105 are arranged in a specific configuration, their arrangement does not adhere to a strict sequence of steps to be performed by one or more users.

In implementations where the recess 107 and the fastener surface 304 are threaded, coupling adjacent modular units further comprises aligning the fastener surface 304 of one modular unit with the recess 107 of an adjacent modular unit. Gentle pressure is then applied while rotating either modular unit to engage the threads of the fastener surface 304 with those of the recess 107 and rotated until the connection is tightened. In other implementations, coupling adjacent modular units may further comprise aligning the fastener surface 304 of one modular unit with the recess 107 of an adjacent modular unit and pressing the modular units together. In implementations where modular units until screw through holes and screw receiving holes, screw or bolts (e.g., screws 1116b, 1216b) may be screwed into each view electric or manual screw driver.

The user couples the shoulder modular unit 101 and the upper modular unit 102 by aligning the protruding surface 108 of the upper arm modular unit 102 and the recess 201 of the shoulder modular unit 102. The two modular units are pressed against each other to couple the modular units together.

In some implementations, assembling the appendage further comprises inserting pins through pin holes. Pins 701a. 701b, 701c, 701d are successively inserted through pin holes 114a of the shoulder, bicep, forearm, and hand modular units 101, 103, 104, and 105, respectively. Each pin is inserted through a respective pin hole and pushed through the pin hole until the top end of the pin is substantially flush with the exterior surface of the appendage 100.

In some implementations, assembling the appendage further comprises inserting hose barb connectors 801 in the band 301 of the upper arm modular unit 102. A hose barb connector 801 can be inserted into each of the channel openings 111a, 111b of the upper arm modular unit 102 prior to coupling the modular unit with the shoulder modular unit 101. A hose barb connector 801 can be inserted into each of the channel outlets 302a, 302b of the upper arm modular unit 102 prior to coupling the modular unit with the bicep modular unit 103.

In some implementations, at step 1404, inserting wound profiles 901a, 901b, 901c in slots 106a, 106b, 106c of the appendage 100, can comprise selecting and inserting specific wound profiles (i.e., any one of wound profile 901a, 901b, 901c) into specific slots (i.e., slots 106a 106b, 106c, 1112a, 1112b or others formed within appendage 100 or appendage 1100) of the appendage 100 or appendage 1100.

At step 1406, a pump is connected to one or more openings of the appendage. The step 1406 further comprises connecting the pump to the channel openings 110a, 110b disposed on the first end 101b of the shoulder modular unit 101.

At step 1408, fluid (e.g., water, dyed water, simulant blood) is flowed through the appendage 100. The step 1408 further comprises turning the pump on to flow fluid from one end of the appendage, through channels disposed within the appendage, through slots 106a, 106b, 106c, 1112a, 1112b and through wound profiles 901a, 901b, 901c inserted in the slots 106a, 106b, 106c.

At step 1410, users can apply flow restricting devices to different areas of the appendage. In some implementations, a user can apply a tourniquet around the upper arm modular unit 102. In those implementations, the user tightens the tourniquet and observes the flow of fluid through the wound profiles for indication of effective tourniquet application. In some implementations, a user can apply wound packing materials to one or more wound profiles 901a, 901b, 901c. In those implementations, the user packs one more wound profiles 901a, 901b, 901c with wound packing materials and observes the flow of fluid through the packed wound profile for indication of effective wound packing.

In any of the above-described steps, wound profiles 901a, 901b, 901c can be removed and exchanged between the different slots 106a, 106b, 106c, 1112a, 1112b of the appendage to create varied scenarios for the user. The pump can be turned off prior to exchanging the wound profiles 901a, 901b, 901c between the different slots 106a, 106b, 106c, 1112a, 1112b.

The method of training with an implementation of an appendage for simulating active bleeding and wounds can further comprise disassembling the appendage 100 into modular units 101, 102, 103, 104, 105, 1103, 1200, 1300 (i.e., uncoupling modular units). The step of disassembling the appendage into modular units can further comprise at least one or more of the following steps: disconnecting the pump from the appendage, removing inserted pins 701a, 701b, 701c, 701d, removing wound profiles 901a, 901b, 901c, and removing hose barb connectors 801, unscrewing screws 1116b, 1216b. Advantageously, by providing a training appendage capable of easy assembly and disassembly, the training appendage may be easily transported and stored without risk of damage.

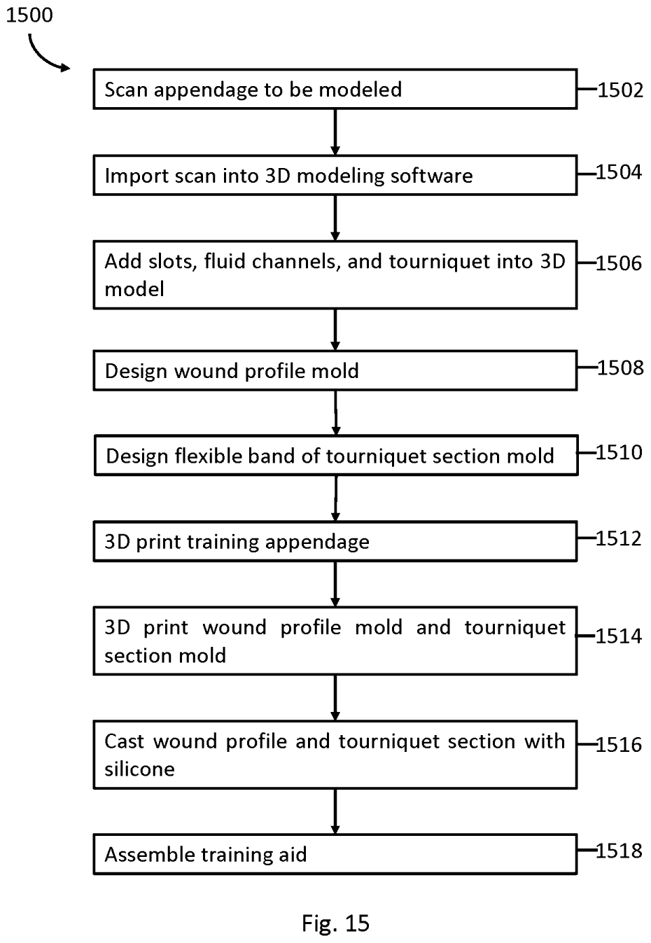

Referring now to FIG. 15, which illustrates a flow diagram of an example manufacturing method 1500 of an appendage training aid. For example, manufacturing method 1500 may be used to create appendage 100 of FIG. 1 and/or appendage 1100 of FIG. 10. The example manufacturing method 1500 includes scanning an appendage to be modeled, at step 1502, importing the scan into a 3D modeling software, at step 1504, adding slots, fluid channels, and a tourniquet section into the 3D model, at step 1506, designing a wound profile mold, at step 1508, designing a flexible band for the tourniquet section mold, at step 1510, 3D printing the training appendage, at step 1512, 3D printing the wound profile mold and tourniquet section mold, at step 1514, casting the wound profile and tourniquet section with silicone, at step 1516, and assembling the appendage training aid, at step 1518.

At step 1502, a human appendage may be scanned to produce a model of such an appendage. In several embodiments, the human appendage is an arm taken from the shoulder to the tip of the fingers. In other embodiments, the human appendage is a leg taken from the thigh to the tip of the toes. However, the appendage scanned may include a subset of an arm or a leg, for example, from the elbow to the shoulder or from the knee to the ankle. In several embodiments, step 1502 is accomplished via use of a 3D scanner.

At step 1504, the scan of the human appendage is imported into a 3D modeling software. The 3D modeling software may be any suitable modeling software capable of rending a 3D scan of a human appendage known in the art. For example, the 3D modeling software may be Autodesk Fusion360. Additionally or alternatively, at step 1504 the scan may be edited to remove imperfections, errors, or otherwise based on the desire. For example, at step 1504, the appendage model may be shortened to only include a subset of the human appendage.

At step 1506, slots, fluid channels, and a tourniquet section are added to the human appendage model. In several embodiments, the 3D modeling software is utilized to input additional components into the appendage model. In several embodiments, the slots input at step 1506 are substantially analogous to slots 106a, 106b, 106c, 1112a, 1112b. However, one of ordinary skill in the art will appreciate that, based on the need, slots may be input on any portion of the appendage model. For example, slots may be added to a shoulder modular unit 101, an upper arm modular unit 102, a bicep modular unit 103, 1102, a forearm modular unit 104, 1200, and a hand modular unit 105, 1300. In several embodiments, one slot is included on the bicep modular unit 103 and one slot is added to the forearm modular unit 104. In some embodiments, several slots may be input onto a single modular unit. However, the present invention contemplates input any number of slots on any number of modular units. In several embodiments, the slots added to the appendage model are configured to accommodate a wound profiles 901a, 901b, 901c.

In several embodiments, the fluid channels input at step 1506 are substantially analogous to the fluid channels derived from channel openings 112a, 112b, channel openings 110a, 110b, channel opening 113, channel openings 1114a, 1114b, 1214a, channel outlets 302a, 302b, channel outlets 202a, 202b, and channel outlet 402. Stated otherwise, the fluid channels included into the appendage model at step 1506 form a continuous fluid channel through each modular unit of the appendage 100 or appendage 1100 and may comprise channel openings 112a, 112b, channel openings 110a, 110b, channel opening 113, channel openings 1114a, 1114b, 1214a, channel outlets 302a, 302b, channel outlets 202a, 202b, and channel outlet 402.

In several embodiments, the tourniquet section is substantially analogous to band 301 and upper arm modular unit 102. In several embodiments, at step 1506, a portion of the appendage model is identified as the upper arm modular unit 102 and is characterized as such using the 3D modeling section. Such characterization may include excluding this section of the appendage from 3D printing.

Additionally or alternatively, coupling components may be added at step 1506. For example, each modular component may be modeled to include a fastener surface, a protrusion, and a corresponding recession collectively forming attachment means for each modular component thereby enabling attachment upon formation. As another example, each modular unit may be modeled to include pin holes, grooves, threaded holes, and the like to facilitate attachment and fastening means described herein. In several embodiments, the coupling components added at step 1506 are substantially analogous to fastener surface 304, recess 201, and recess 107.

At step 1508, a wound profile mold is design. In several embodiments, utilizing the 3D modeling software, several wound profile molds may be made based on the need. The wound profile molds designed as step 1508 may be substantially analogous to small bullet hole wound profile 901a, large bullet hole wound profile 901b, and/or slash wound profile 901c. In several embodiments, the wound profile mold is designed with a first opening (e.g., first openings 902a, 902b 902c) and a second opening (e.g., second openings 903a, 903b, 903c), such that fluid may flow from the fluid channels through the wound profiles thereby simulating active bleeding. While FIGS. 9A-9E illustrate various example wound profiles, other wound profiles are contemplated herein (e.g., stab wound, surgical wounds, punctures, burns, abrasion, etc.). Accordingly, such a variety of wound profiles may be made through the wound profile molds designed at step 1508.

At step 1510, a flexible band of the tourniquet section mold is designed. In several embodiments, utilizing the 3D modeling software, the flexible band may be formed to accommodate an exterior section of the torniquet section identified and characterized at step 1506. The tourniquet section mold may be designed based off the appendage model formed at step 1504, such that the mold is configured to outline a flexible band operable to accommodate the upper arm section. In several embodiments, the flexible band mold is configured to form flexible band 301 upon casting.

At step 1512, the training appendage is 3D printed. In several embodiments, the training appendage 3D printed at step 1512 is substantially analogous to appendage 100 of FIG. 1 or appendage 1100 of FIG. 10. In several embodiments, the training appendage is based on the scan acquired at step 1502. In many embodiments, the training appendage 3D printed at step 1512 includes a shoulder modular unit 101, an upper arm modular unit 102, a bicep modular unit 103, 1103, a forearm modular unit 104, 1200, and a hand modular unit 105, 1300. Such modular units may be printed separately or collectively. In some embodiments, the training appendage 3D printed at step 1512 does not include an upper arm modular unit 102, such that one may be cast at step 1516. In several embodiments, step 1512 is accomplished utilizing a Bambu Lab PIP 3D printer; however, any similar 3D printer known in the art may be used.

In several embodiments, the training appendage 3D printed at step 1512 may be formed of a polylactic acid (PLA) material, a thermoplastic polyurethanes (TPU) material, and/or other similar material known in the art. Advantageously, a PLA material may provide a cheap material while maintaining sufficient stiffness and strength for training uses. Advantageously, a TPU material may provide a durable material that simulates silicone material. Additionally, the TPU material may have high impact resistance, flexibility, temperature resistance, and facilitate quick 3D printing speed. Notably, a proper material must be selected to provide a training appendage sufficient to handle training exercises, such as those present in TCCC training. For example, the training appendage (e.g., appendage 100, 1100) of the present disclosure is designed to simulate active bleed and be used for training purposes. Based on the need, such a training appendage may be utilized in intense and rough training environments, such as battle fields, rugged terrain, and moving vehicles. As such, the training appendage must be formed of a material equipped to handle such environments while also providing a cost-effective means for mass production. Advantageously, forming the training appendage from PLA or TPU material satisfies such a requirement.

At step 1514, the wound profile mold and tourniquet section mold is 3D printed. In several embodiments, the wound profile mold and tourniquet section mold are based on the designs created in steps 1508 and 1510. As such, the wound profile mold may be configured to form a wound profile substantially analogous to wound profiles 901a, 901b, and 901c. The tourniquet section mold may be configured to form a tourniquet section substantially analogous to band 301.

At step 1516, the wound profile and tourniquet section are cast using silicone. In several embodiments, the silicone used to cast the wound profile and tourniquet section is initially mixed to form a silicone material that resembles or is similar to the hardness of human skin. Such mixed silicone may then be used to cast the various wound profiles and tourniquet section printed in step 1514. As such, the resulting wound profile cast may be substantially analogous to wound profiles 901a, 901b, and 901c. Additionally, the resulting tourniquet section may be substantially analogous to flexible band 301. In some embodiments, the wound profile and tourniquet section are cast of PLA or TPU.

At step 1518, the training appendage is assembled. Step 1518 may be substantially analogous to step 1005 of FIG. 14. In several embodiments, the training appendage comprises coupling modular units 101, 102, 103, 104, 105 using the connection mechanism between the modular units. In other embodiments, the training appendage comprises coupling modular units 101, 102, 1103, 1200, 1300 using connection mechanism between the modular units. For example, a user couples the second end 101b of the shoulder modular unit 101 with the first end 102a of the upper arm modular unit 102. The coupled modular units 101, 102 are then coupled with the bicep modular unit 103 by coupling the second end 102b of the upper arm modular unit 102 to the first end 103a of the bicep modular unit 103. The coupled modular units 101,102,103 are then coupled with the forearm modular unit 104 by coupling the second end 103b of the bicep modular unit 103 to the first end 104a of the forearm modular unit 104. The coupled modular units 101,102,103,104 are then coupled with the hand modular unit 105 by coupling the second end 104b of the forearm modular unit 104 to one end of the hand modular unit 105. Thus, a training aid resembling a human appendage is formed. In several embodiments, step 1518 further includes inputting the wound profiles and tourniquet section cast at step 1516 into their respective locations. For example, wound profiles 901a, 901b, and/or 901c may be input into slots 106a, 106b. Additionally or alternatively, the tourniquet section (e.g., band 301) may be placed about bone body 305 thereby forming upper arm modular unit 102, which may be subsequently included in the assembled appendage training aid.

The disclosed system and method address the shortcomings of existing training aids and offers active bleeding simulation, a mechanism for visual feedback for tourniquet application and wound packing application, and variability in training scenarios through interchangeable wound profiles. By way of example, the disclosed system and method effectively meet training goals of medical trainings such as TCCC training and enhance the readiness and proficiency of trainees in life-saving techniques.

The disclosed system and method may be embodied in other specific forms without departing from the spirit or essential characteristics thereof. The foregoing implementation are therefore to be considered in all respects illustrative, rather than limiting of the invention.

What is claimed is:

1. A training aid comprising:
a plurality of modular appendage units removably attachable to one another thereby forming a continuous appendage collectively resembling a human appendage upon assembly;
the plurality of modular appendage units including at least one slot;
each modular appendage unit comprising a fluid channel configured to enable passage of a fluid therethrough;
wherein the fluid channels of each modular appendage are configured to form a continuous fluid channel through the plurality of modular appendage units upon assembly;
wherein the fluid channels are operable to deliver a fluid to the at least one slot;
the plurality of modular appendage units including at least one tourniquet section operable, upon compression force, to constrict a fluid channel disposed therein and at least partially preventing fluid flow through the at least one slot.

2. The training aid of claim 1, further comprising a plurality of attachment components configured to facilitate removable attachment of the plurality of modular appendage units.

3. The training aid of claim 2, wherein the plurality of attachment components comprises at least one protrusion and/or at least one recession disposed on each of the plurality of modular appendage units;
wherein the at least one protrusion is configured to couple to a recession of a corresponding attachment unit; and
wherein the at least one recession is configured to couple to a protrusion of a corresponding attachment unit.

4. The training aid of claim 3, wherein the at least one protrusion comprises a threaded portion and the at least one recession includes a corresponding threaded recess.

5. The training aid of claim 2, further comprising at least one fastener configured to secure attachment of the plurality of modular appendage units.

6. The training aid of claim 5, wherein the at least one fastener comprises at least one pin configured to couple to at least one pin hole disposed on an outer surface of each of the modular appendage units and extending through each of the at least one attachment components; and
wherein the at least one pin hole is configured to receive the at least one pin thereby securing attachment of the continuous appendage.

7. The training aid of claim 1, wherein the plurality of modular appendage units comprises a shoulder unit, an upper arm unit, a bicep unit, a forearm unit, and a hand unit.

8. The training aid of claim 1, wherein the at least one slot is configured to receive an interchangeable wound profile;
wherein the interchangeable wound profile includes a first opening resembling a wound; and
wherein the interchangeable wound profile includes a second opening configured to couple to the continuous fluid channel and receive a fluid.

9. The training aid of claim 1, wherein the plurality of modular appendage units comprises at least two slots, each fluidly coupled to the continuous fluid channel.

10. The training aid of claim 9, wherein the plurality of modular appendage units comprises at least two tourniquet sections operable, upon compression force of both tourniquet sections, to constrict a fluid channel disposed therein and at least partially preventing fluid flow through the at least one slot.

11. The training aid of claim 2, wherein the plurality of attachment components comprises
at least one protrusion and corresponding recession; and
at least one screw through hole and at least one corresponding screw receiving hole configured to receive a screw.

12. A modular appendage unit comprising:
a flexible band defining a hollow passage;
an attachment unit configured to occupy the hollow passage comprising;
a protrusion and a recession;
wherein the protrusion is positioned on a first end of the attachment unit and the recession is positioned on a second end of the attachment unit;
wherein the protrusion is configured to couple to a recession of a corresponding attachment unit;
the flexible band comprising at least one fluid channel configured to enable passage of a fluid through the flexible band;
wherein the flexible band is configured, upon application of pressure, to compress thereby reducing or entirely restricting flow of fluid through the at least one fluid channel.

13. The modular appendage unit of claim 12, wherein the modular appendage unit is operable, by the attachment unit, to removably attach to another appendage unit comprising the corresponding attachment unit thereby facilitating removeable connection of a plurality of appendage units.

14. The modular appendage unit of claim 13, wherein the modular appendage unit comprises an upper arm section; and
wherein the plurality of appendage units comprises a shoulder section, a bicep section, a forearm section, and a hand section.

15. The modular appendage unit of claim 13, wherein the at least one fluid channel extends through the modular appendage unit and the plurality of appendage units thereby forming a continuous fluid channel.

16. The modular appendage unit of claim 15, wherein at least one of the plurality of appendage units comprises a slot fluidly coupled to the continuous fluid channel and configured to receive a wound profile.

17. The modular appendage unit of claim 12, wherein the flexible band is configured to compress upon receiving pressure application by a tourniquet thereby reducing or entirely restricting flow of fluid through the at least one fluid channel.

18. A method for simulating active bleeding of wounds on a training aid comprising:
assembling a training appendage resembling a human appendage by coupling a plurality of modular appendage units;
wherein the plurality of modular appendage units comprises a fluid channel and at least one slot;
wherein the fluid channel is configured to form a continuous fluid channel through the plurality of modular appendage units upon assembly;
wherein the at least one slot is configured to receive a wound profile;
wherein the at least one slot and the wound profile are fluidly coupled to the continuous fluid channel;
inserting the wound profile into the at least one slot;
connecting a pump to a fluid channel opening of a modular appendage unit of the plurality of modular appendage units;
pumping a fluid into the continuous fluid channel and out of the wound profile thereby simulating active bleeding of wounds;

19. The method of claim 18, further comprising applying a flow restricting device to at least one of the plurality of module appendage units thereby at least partially restricting a flow of fluid exiting the wound profile.

20. The method of claim 18, further comprising packing the wound profile with a wound packing material thereby at least partially restricting a flow of fluid existing the wound profile.
